(19) United States
(12) Patent Application Publication
(10) Pub. No.: US 2007/0269575 A1
(43) Pub. Date: Nov. 22, 2007

(54) Method for Untrafinely Pulverizing Oat Bran and a Beverage Composition Comprising an Extract Extracted from an Ultrafine Oat Bran Powder Obtained by the Method

(75) Inventors: Byoung-Hak Min, Incheon-city (KR); Kenny Sohn, Kyungki-do (KR); Richard Kim, Kyungki-do (KR); Heon-Sang Jeong, Chungcheongbuck-do (KR)

Correspondence Address: CANTOR COLBURN, LLP, 55 GRIFFIN ROAD SOUTH, BLOOMFIELD, CT, 06002, US

(73) Assignee: CJ CORPORATION, Seoul (KR)

(21) Appl. No.: 11/574,147

(22) PCT Filed: Aug. 25, 2005
(86) PCT No.: PCT/KR05/02814

§ 371 Date: Feb. 23, 2007

(30) Foreign Application Priority Data
Aug. 25, 2004 (KR) 1020040067100

(51) Int. Cl. B02B 5/02

(52) U.S. Cl. 426/598; 241/29

(57) ABSTRACT

A method of ultrafinely pulverizing oat bran and a beverage composition containing an effective oat bran component prepared using the method are provided. The method includes primarily pulverizing oat bran, and jetting the primarily pulverized oat bran powder at a high rate to collide against a freeze wall. The effective oat bran component in the beverage composition is extracted by adding warm water to ultrafinely pulverized oat bran powder obtained using the method and stirring the mixture.

### TECHNICAL FIELD

The present invention relates to a method of ultrafinely pulverizing oat bran and a beverage composition containing an oat component extracted from oat bran powder obtained using the method.

### BACKGROUND ART

β-glucan ((1-3),(1-4)-β-D-glucan) is a kind of dietary fiber which is undigested in the human body. β-glucan is an effective bioactive material which lowers blood cholesterol level and LDL-cholesterol level, raises HDL-cholesterol level, and blocks cholesterol accumulation in liver and cholesterol absorption.

Conventional methods of separating β-glucan from cereals include pulverizing cereals into powder, adding warm water to separate β-glucan in the water, and inactivating β-glocanase in the cereals. For example, Korean Patent Laid-open publication No. 1999-65617 discloses a method of separating solid β-glucan from cereals by pulverizing cereals containing β-glucan into powder of 0.5 mm or less in diameter, adding water to the powder to extract β-glucan in the solution, heating the solution containing the extracted β-glucan to inactivate β-glocanase and coagulate protein, adding amylase to the solution and allowing reaction therein, separating the solution from the solid mass by filtration, adding an alcohol into the filtered solution to separate β-glucan in solid form.

However, all such conventional methods are for separating pure β-glucan, not together with other effective components in cereals. In addition, most of the conventional methods use a pulverizing method in which cereals are pulverized by the friction between two metal plates. In this pulverizing method, the number of frictioning processes should be increased to obtain smaller powder. However, during these repeated frictioning processes, high-temperature heat, for example, up to about 190° C., can be generated. The more the frictioning processes are repeated, the longer the duration for which cereals are exposed to high-temperature heat and the greater the possibility that other effective components in cereals are decomposed. In addition, the costs increase. Therefore, there is a limit to the size of powder that can be obtained using the conventional method. In addition, a conventional method of preparing a beverage composition containing high-concentration β-glucan includes extracting pure β-glucan from cereals, concentrating the β-glucan extract, and then adding the concentrated β-glucan extract. In other words, a beverage composition containing high-concentration β-glucan cannot be obtained directly from cereals using the conventional method. Other effective components in addition to β-glucan in cereals cannot be simultaneously separated using the conventional method.

However, as a result of researching into a method of simultaneously separating high-concentration β-glucan and other effective components from oat bran, the inventors of the present invention have found that β-glucan and other effective components can be simultaneously extracted using a low-temperature pulverizing method and completed the present invention.

### DETAILED DESCRIPTION OF THE INVENTION

### Technical Problem

The present invention provides a method of ultrafinely pulverizing oat bran.

The present invention provides a beverage composition containing an effective oat component extracted from oat bran powder obtained using the method.

### Technical Solution

According to an aspect of the present invention, there is provided a method of ultrafinely pulverizing oat bran, the method including primarily pulverizing oat bran, jetting the pulverized oat bran powder at a high speed to collide against a freeze wall to obtain ultrafine oat bran powder.

Oat bran used in the present invention refers to residual products obtained as a result of separating oat germ from oats. In general, oat bran contains a large amount of β-glucan, for example, up to about 8%, and avenanthramide and tocopherol, which have anti-inflammation and anti-atherosclerosis effects. Oat bran used in the present invention may contain 6-8% or greater β-glucan, but is not limited thereto. However, these effective components are unstable to heat and thus the generation of heat has to be suppressed to prevent decomposition of these components.

According to the present invention, primarily pulverized oat bran is further pulverized into ultrafine powder by being jet to collide against a freeze wall. The primarily pulverizing process is a preliminary process performed before the oat bran is collided against the freeze wall. The primarily pulverized oat bran powder may have a particle size of 20 mesh or less. The primarily pulverizing process may be performed using any conventional method, for example, a method in which less heat is generated. In an embodiment according to the present invention, the primarily pulverized oat bran powder having a size of 20 mesh or less is dried by blowing hot air until the moisture content reaches 5% or less and put into a pulverizer with a jet nozzle. The dried oat bran powder is jet at a rate of 95-100 m/sec and room temperature to collide against the freeze wall, thereby being further pulverized. The temperature of the freeze wall may be in a range of −15-−20° C. In addition, the temperature of the final ultrafinely pulverized oat bran powder is 40° C. or less because no heat is generated during the collision.

The size of the final oat bran powder ultrafinely pulverized by freeze jetting according to the present invention may be smaller than 500 mesh, for example, smaller than 2,500 mesh. In the present invention, the low-temperature jetting may be performed by jetting the primarily pulverized oat bran at a temperature of, for example, −20° C., and a rate of 100 m/sec to obtain oat bran powder of 2,500 mesh or less. Under this condition, heat generation is suppressed so that the temperature of the oat bran powder does not exceed 40° C.

A method of extracting effective oat bran components from the ultrafinely pulverized oat bran powder may be any conventional method. For example, an effective oat bran component, such as β-glucan, may be separated by adding warm water of a predetermined temperature to the ultrafinely pulverized oat bran powder and stirring the mixture. In particular, the method of extracting effective oat bran components may include adding water of 50-80° C. to the ultrafinely pulverized oat bran powder in a volume ratio of 5-10:1 and stirring the mixture. The stirring may be performed at 100-400 rpm for 1-2 hours.

A method of extracting effective oat bran components according to the present invention may optionally include a costly separation process after the effective components have been extracted from the ultrafinely pulverized oat bran powder by warm water extraction. Conventional extraction methods require a costly separation process after effective components have been extracted by warm water extraction. However, the method of extracting effective oat bran components according to the present invention provides a high yield because the ultrafinely pulverized oat bran powder is used. Therefore, according to the present invention, the costly separation process is optional, and the extract obtained by warm water extraction can be directly used as a beverage composition.

The effective oat bran component extract solution containing β-glucan may contain an active β-glucanase, which originates from oat bran and can be deactivated by heating, for example, at 70-100° C. In addition, when the viscosity of the extract solution is high, it can be lowered by hydrolyzing starch in the extraction solution. In particular, the viscosity of the extract solution may be lowered by hydrolyzing the starch using a starch decomposing enzyme, for example, α-amylase.

The present invention also provides a beverage composition containing an effective oat bran component extracted by adding warm water into the ultrafine oat bran powder obtained using the ultrafinely pulverizing method described above and stirring the mixture.

A beverage composition according to an embodiment of the present invention may be prepared using a method including adding 3-8% by weight of oat germ powder into the beverage composition containing only effective oat bran components, heating the mixture to deactivate β-glucanase, and adding a starch decomposing enzyme into the mixture to liquify the mixture.

In an embodiment according to the present invention, the effective oat bran component may be at least one selected from the group consisting of β-glucan, avenanthramide, and tocopherol.

In an embodiment according to the present invention, the beverage composition may contain 0.5% or greater of β-glucan. Alternatively, the beverage composition according to the present invention may further include an additive, such as fruit juice, a sweetener, a vitamin, a mineral, etc., in addition to β-glucan.

### Advantageous Effects

In a method of ultrafinely pulverizing oat bran according to the present invention, oat bran can be ultrafinely pulverized to a size of 2,500 mesh or less while generating less heat.

A beverage composition using an oat bran extract according to the present invention contains other effective components in addition to β-glucan and thus is nutritionally and pharmaceutically effective.

### Best Mode

The present invention will be described in more detail with reference to the following examples. The following examples are for illustrative purposes and are not intended to limit the scope of the present invention.

### EXAMPLES

### Example 1

### Establishment of Optimal Condition for β-glucan Extraction

Oat bran containing about 8-10% by weight of β-glucan was used.

1. Ultrafine Pulverization of Oat Bran

Oat bran was primarily pulverized to a size of 20 mesh or less using rollers and dried using hot air until the moisture content reached 5% or less. The primarily pulverized oat bran powder was put into a ultra fine pulverizer (available from Korea Energy Technology) at room temperature and jet at 95-100 m/sec to collide against a freeze wall of −15-−20° C. to obtain ultrafine oat bran powder of about 2,500 mesh. The temperature of the final product was maintained at 40° C., not to rise to 190° C. or greater as in conventional methods, and thus there were no changes in physical properties.

2. Effect of Water Temperature on β-glucan Extraction

Samples, each containing 10% of oat bran (8% by weight of β-glucan, 50 mesh) in purified water, were stirred at 300 rpm for 2 hours to extract β-glucan. The extraction temperature for each of the samples was varied in a range of 35-95° C. Each of the samples was filtered using a 200-mesh sieve for 10 minutes to separate a β-glucan containing solution and solids. The extraction ratio of β-glucan was adequate at an extraction temperature of 55-95° C., and highest at 75° C.

3. Effect of Extraction Time on β-glucan Extraction

Samples, each containing 10% of oat bran (8% by weight of β-glucan, 50 mesh) in purified water, were stirred at 300 rpm and 75° C. for 20-100 minutes to extract β-glucan. The extraction time for each of the samples was varied in a range of 20-100 minutes. Each of the samples was filtered using a 200-mesh sieve for 10 minutes to separate a β-glucan containing solution and solids. The extraction ratio of β-glucan was adequate at an extraction time of 40 minutes or longer and did not changed any longer after 60 minutes of extraction.

4. Effect of pH on 3-glucan Extraction

Samples, each containing 10% of oat bran (8% by weight of β-glucan, 50 mesh) in purified water, were stirred at 300 rpm and 75° C. for 1 hour to extract β-glucan. The pH of each of the samples was varied in a range of pH 3-8 using phosphoric acid and sodium hydroxide, which are used as food additives. Each of the samples was filtered using a 200-mesh sieve for 10 minutes to separate a β-glucan containing solution and solids. The extraction ratio of β-glucan was highest at pH 5 and pH 8.

5. Effect of the Size of Oat Bran Powder on β-glucan Extraction

Samples, each containing 10% of oat bran (8% by weight of β-glucan, 50 mesh) in purified water, was stirred at 300 rpm, 75° C., and pH 8 for 1 hour to extract β-glucan. The sizes of oat bran in the samples were different. Each of the samples was filtered using a 200-mesh sieve for 10 minutes to separate a β-glucan containing solution and solids. The results are shown in Table 1. Referring to Table 1, when the size of oat bran powder is 500 mesh or less, the amount of extracted β-glucan is satisfactory. In addition, 95% or more of β-glucan existing in oat bran can be extracted using oat bran having a size of 2,500 mesh.

TABLE 1
Effect of particle size on β-glucan extraction
Oat bran

| 50 mesh | 100 mesh | 500 mesh | 2,500 mesh |
|---|---|---|---|
| 0.32 | 1.90 | 5.61 | 7.52 |

Based on the results described above, oat bran containing 8% by weight of β-glucan was pulverized to a size of 2,500 mesh or less, added to purified water in a 1:9 ratio by volume, stirred at 300 rpm, 75° C., and pH 8 for 1 hour, and filtered using a 200-mesh sieve for 10 minutes to separate a β-glucan containing solution and solids. The amount of β-glucan in the solution was 0.7% or greater.

In the method according to the present invention established in Example 1, since oat bran is pulverized to a size of 2,500 mesh or less in a freeze condition, the β-glucan extraction efficiency is high, and less heat is generated. Therefore, β-glucan can be extracted without loss of effective components, such as tocopherol and avenanthramide, in oat bran.

### Example 2

### Establishment of the Conditions for Preparing an Oat Beverage Containing β-glucan

The conditions for preparing a β-glucan-containing beverage using the β-glucan containing solution extracted in Example 1 were established in the current example. Oat germ was added to the β-glucan containing solution extracted in Example 1, and the viscosity was appropriately adjusted. Oat germ containing 62% of starch and 17% of protein in addition to β-glucan was added to the beverage to supplement nutrients.

In particular, 5% of oat germ was added to the β-glucan containing solution obtained in Example 1. Due to a large amount of starch in the oat germ, the viscosity of the mixture of 5% of oat germ and the β-glucan containing solution was 98 cp or greater, which is too high to be used as a beverage.

To adjust the viscosity of the mixture to be adequate for beverage, α-amylase, which is a starch liquefying enzyme, was added to the mixture and reacted. When 3% by weight of -amylase, on a solid basis, was added to the mixture and reacted at pH 6.8 and 300 rpm for 1 hour, the viscosity of the resulting solution was 18 cp, which is shown in Table 2. This viscosity is suitable for a beverage. Table 3 shows change in viscosity according to the amount of α-amylase.

TABLE 2
Change in physical property before and
after treatment with α-amylase

| | Before treatment with | After treatment with |
|---|---|---|
| | α-amylase | α-amylase |
| Viscosity | 98 cp | 18 cp |

TABLE 3
Change in physical property according
to the amount of α-amylase

| | 10 min | 30 min | 40 min | 50 min | 60 min | 80 min |
|---|---|---|---|---|---|---|
| 0.05% | 50 | 41 | 28 | 26 | 25 | 24 |
| 0.1% | 45 | 31 | 24 | 22 | 21 | 20 |
| 0.2% | 36 | 27 | 21 | 20 | 19 | 18 |
| 0.30% | 33 | 27 | 21 | 19 | 18 | 18 |
| 0.40% | 28 | 24 | 20 | 19 | 16 | 16 |
| 0.50% | 26 | 20 | 16 | 14 | 14 | 12 |

Based on the results of Examples 1 and 2, the optimal conditions for extracting β-glucan from oat bran and adding oat germ to prepare a beverage containing effective oat bran components including β-glucan were established.

### Example 3

### Preparation of an Oat Beverage Containing β-glucan

Based on the results of Examples 1 and 2, a beverage containing effective oat bran components including β-glucan was prepared by obtaining a solution including β-glucan extracted from oat bran, adding oat germ to the solution, and appropriately adjusting the viscosity of the solution was prepared.

In particular, 10 kg of oat bran containing 8% of β-glucan was ultrafinely pulverized under the conditions as in Example 1 to obtain oat bran powder of a size of 2,500 mesh. Water was added to oat bran powder in a volume ratio of 9:1 and reacted at 300 rpm, 75° C., and pH 8 for 1 hour. The resultant solution containing effective oat bran components contained 0.7% of β-glucan.

Next, 5% of oat germ powder was added into the solution containing effective oat bran components including β-glucan and heated at 98° C. for 20 minutes to deactivate natural β-glucanase present in oat. 0.3% by weight of α-amylase on a solid basis, which is a starch liquifying enzyme, was added to the solution and reacted pH 6.8, 300 rpm, 55° C. for 1 hour, and further at 85° C. for 10 minutes to deactivate α-amylase. As a result, a solution having a viscosity of 18 cp was obtained.

In addition, food additives, such as citric acid, a salt, a vitamin, and a flavoring agent, were added to the solution and sterilized at 140° C. for 6 seconds to obtain a β-glucan-containing beverage.

1. A method of ultrafinely pulverizing oat bran, the method comprising:
primarily pulverizing oat bran; and
jetting the primarily pulverized oat bran powder at a high rate to collide against a freeze wall to obtain ultrafinely pulverized oat bran powder.

2. The method of claim 1, wherein the temperature of the freeze wall is in a range of −15-−20° C., and the jetting rate is in a range of 95-100 m/sec.

3. The method of claim 1, wherein the size of the ultrafinely pulverized oat bran powder is smaller than 500 mesh.

4. A beverage composition containing an effective oat bran component extracted by adding warm water to the ultrafinely pulverized oat bran powder obtained using the method of claim 1 and stirring the mixture.

5. The beverage composition of claim 4, being obtained by additionally adding 3-8% by weight of oat germ powder to the mixture, heating the mixture to deactivate β-glucanase, and adding an amylase to liquify starch.

6. The beverage composition of claim 4, wherein the effective oat bran component is at least one selected from the group consisting of β-glucan, avenanthramide, and tocopherol.

7. A beverage composition containing an effective oat bran component extracted by adding warm water to the ultrafinely pulverized oat bran powder obtained using the method of claim 2 and stirring the mixture.

8. A beverage composition containing an effective oat bran component extracted by adding warm water to the ultrafinely pulverized oat bran powder obtained using the method of claim 3 and stirring the mixture.

9. The beverage composition of claim 7, being obtained by additionally adding 3-8% by weight of oat germ powder to the mixture, heating the mixture to deactivate β-glucanase, and adding an amylase to liquify starch.

10. The beverage composition of claim 8, being obtained by additionally adding 3-8% by weight of oat germ powder to the mixture, heating the mixture to deactivate β-glucanase, and adding an amylase to liquify starch.

11. The beverage composition of claim 7, wherein the effective oat bran component is at least one selected from the group consisting of β-glucan, avenanthramide, and tocopherol.

12. The beverage composition of claim 8, wherein the effective oat bran component is at least one selected from the group consisting of β-glucan, avenanthramide, and tocopherol.
